(19) United States
(12) Patent Application Publication
(10) Pub. No.: US 2011/0178703 A1
(43) Pub. Date: Jul. 21, 2011

(54) NAVIGATION APPARATUS AND METHOD

(76) Inventors: Sjoerd Aben, Alkmaar (NL); Erik Thomassen, Amsterdam (NL); Teun De Haas, Utrecht (NL)

(21) Appl. No.: 12/736,862

(22) PCT Filed: Jan. 14, 2009
(86) PCT No.: PCT/EP2009/050383

§ 371 Date: Jan. 25, 2011

(51) Int. Cl. G01C 21/00; B60Q 1/48

(52) U.S. Cl. 701/207; 340/932.2

(57) ABSTRACT

A navigation apparatus includes an input device for receiving time data representative of a user return time by when a user is to return to a parked vehicle, and a processor configured to monitor the time remaining until the user return time and to provide an alarm signal in dependence on the time remaining.

### FIELD OF THE INVENTION

The present invention relates to a navigation apparatus and method and in particular to the use of such navigation apparatus and method in relation to a parked vehicle.

### BACKGROUND TO THE INVENTION

Portable navigation devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

Although devices such as those described above have great utility in improving the driving experience for a user in a vehicle, the user may experience numerous problems or inconveniences when the vehicle is parked that are not addressed by known devices.

For example, when parking a vehicle in a paid parking area it is often difficult for a user to remember at what time a parking ticket will expire. It is also annoying to the user to constantly need to check if the time to return to the vehicle has arrived. Furthermore, it may also be difficult for a user to judge the amount of time needed to walk back to the vehicle, and thus the time at which he or she should set off in order to arrive at the vehicle at the last moment before expiry of the parking period, so as to obtain the most benefit from the parking payment.

A user may write down at what time a parking period expires, if a parking ticket with that information is not provided, but it is still necessary for the user to repeatedly check the current time to see if the parking period expiry time is nearing and to judge how long it might take to return to the vehicle, which can cause stress to the user. A user may also insert extra money into a parking meter to be on the safe side, or risk returning to the vehicle late, after expiry of the parking period.

### SUMMARY OF THE INVENTION

According to a first aspect of the present invention, there is provided a navigation apparatus, comprising:—an input device for input of time data representative of a user return time by when a user is to return to a parked vehicle; and a processor configured to monitor the time remaining until the user return time and to provide an alarm signal in dependence on the time remaining.

The user return time may be a parking period expiry time. The apparatus may comprise a location determining unit for determining the location of the user, wherein the processor is configured to provide the alarm signal in dependence on the location of the user relative to the vehicle.

The processor may be configured to determine the distance between the determined location of the apparatus or the user device and the location of the vehicle and to provide the alarm signal in dependence on the distance. The apparatus may further comprise a memory for storing map data, and the processor may determine the distance between the determined location of the apparatus or the user device and the location of the vehicle using the map data. The processor may comprise a route determining module and the distance between the determined location of the apparatus or the user device and the location of the vehicle may be the distance along a route from the determined location of the apparatus or the user device and the location of the vehicle, determined by the route determining module.

The processor may be configured to estimate the time for the user to travel to the vehicle and to provide the alarm signal in dependence upon the estimated travel time.

The processor may be configured to compare the time remaining to a threshold and to provide the alarm signal if the time remaining is less than or equal to the threshold. The threshold may be equal to one of:—a predetermined offset time; the estimated travel time for the user to travel to the vehicle; or the estimated travel time for the user to travel to the vehicle plus a predetermined offset time.

The apparatus may be a portable navigation device (PND) adapted for carrying and operation by a user when outside the vehicle, and may comprise a location determining unit for determining the location of the device. The determined location of the PND may thus be the location of the user. In the event that the location cannot be determined (for example if the GPS signal, or other location determining signal, is lost) then the location, distance or the time for the user to travel to the vehicle may be determined from historical data, for example historical data representative of whether the user has parked at or near the vehicle location before, whether the user has travelled to or in the direction of the last determined location (for example the last location determined before loss of the GPS or other signal), and previous travel times back to the vehicle location.

The apparatus may further comprise communication circuitry for communicating with a user device adapted for carrying and operation by a user when outside the vehicle, and the processor may be configured to receive via the communication circuitry location data representative of the location of the user device. The location of the user device, represented by the location data, may thus be the location of the user.

The apparatus may be configured to transmit the alarm signal to the or a user device adapted for carrying and operation by a user when outside the vehicle. The user device may be a GPS device and/or may be a mobile phone.

The processor may be configured to monitor for response from the user following provision of the alarm signal. The response may be a request from the user that the alarm is repeated at a later time. The processor may be configured to repeat the alarm signal at a later time in response to the request. Thus a snooze function may be provided.

The processor may be configured to repeat the alarm signal or provide a further alarm signal, if the user does not provide a desired response to the alarm signal. The desired response to the alarm signal may comprise an input from the user via the or an input device and/or the user travelling towards the vehicle.

The processor may be configured to monitor travel of the user following the provision of the alarm signal and to repeat the alarm signal or to provide a further alarm signal in dependence upon travel of the user relative to the vehicle.

The processor may be configured to update and monitor the estimated travel time to the vehicle following the alarm signal in dependence upon the location of the user and/or the apparatus, and to provide a further alarm signal if the estimated travel time is greater than or substantially equal to the time remaining or to provide a further alarm signal if the estimated travel time is greater than or substantially equal to the time remaining plus an offset time.

The apparatus may further comprise an output device responsive to the alarm signal to provide an output to a user, wherein the output comprises at least one of an audio and/or visual and/or tactile alarm, an indication of the user return time, an indication of the time remaining, an offset time, an estimate of time to travel to the vehicle, or a route back to the vehicle.

Alternatively or additionally the navigation device may comprise communication circuitry and the processor may be configured to transmit the alarm signal to a further device using the communication circuitry. The further device may be a mobile phone or other personal user device, and the further device may be responsive to the alarm signal to provide an output to the user.

The apparatus may be configured to determine the location of the vehicle in response to an input indicative that the vehicle is parked. The input may be from a user via an input device that may be included in or associated with the navigation apparatus. Alternatively the input may be an input from an electronic parking management system, for example an electronic parking management system according to which parking can be paid for via a user's mobile phone. The input indicative that the vehicle is parked may be received by the apparatus from the user's mobile phone.

The apparatus may further comprise a memory for storing the location of the vehicle.

The apparatus may be configured to provide an output to the user indicating that a parking payment may be required and/or requesting that the user enters the return time in response to an input indicative that the vehicle is parked. The apparatus may be configured to provide the output to the user in dependence upon the vehicle location.

The processor may be configured to determine from map data whether the vehicle location is in an area where parking payment may be required.

The apparatus may further comprise an interface module for interfacing with an electronic parking management system, configured to provide the return time to the processor.

The processor may be responsive to an indicator of a parking payment to extend the return time. The parking payment may be made via the electronic parking management system and/or the indicator may be provided by the electronic parking management system.

The apparatus may further comprise a power state management module configured to control the apparatus to be in one of at least of a sleep state and an awake state, and to control the apparatus to move from the sleep state to the awake state in dependence on the difference between the current time and the return time.

The processor may be configured to extend the return time in response to input from a user and/or in response to an input indicative that a parking period has been extended.

According to a further, independent aspect of the invention there is provided a method of monitoring a user return time comprising obtaining time data representative of a user return time by when a user is to return to a parked vehicle, monitoring the time remaining until the user return time, and providing an alarm signal in dependence on the time remaining.

In another independent aspect of the invention there is provided a computer program product comprising computer readable instructions executable to put into effect a method as claimed or described herein.

Any feature in one aspect of the invention may be applied to other aspects of the invention, in any appropriate combination. In particular, apparatus features may be applied to method features and vice versa.

### BRIEF DESCRIPTION OF THE DRAWINGS

At least one embodiment of the invention will now be described, by way of example only, with reference to the accompanying drawings, in which:

FIG. 1 is a schematic illustration of a Global Positioning System (GPS) usable by a navigation device;

FIG. 2 is a schematic illustration of electronic components of a navigation device;

FIG. 3 is a schematic diagram of a communications system including a wireless communication channel for communication with the navigation device;

FIGS. 4a and 4b are illustrative perspective views of a navigation device;

FIG. 5 is a schematic representation of an architectural stack of the navigation device of FIG. 2;

FIG. 6 is an illustrative screenshot from the navigation device of FIG. 2;

FIG. 7 is a flow chart illustrating in overview operation of an alarm module included in the navigation device of FIG. 2;

FIG. 8 is a schematic diagram of an alarm system included the navigation device of FIG. 2;

FIG. 9 is a schematic diagram showing the layout of a menu screen displayed by the navigation device;

FIG. 10 is a schematic diagram of a route mapping screen displayed by the navigation device in response to an alarm signal;

FIG. 11 is a schematic diagram of a map screen displayed by the navigation device if no GPS fix is available; and

FIG. 12 is a schematic diagram of an alternative embodiment of an alarm system.

### DETAILED DESCRIPTION OF EMBODIMENTS

Embodiments of the present invention will now be described with particular reference to a PND. It should be remembered, however, that the teachings of the present invention are not limited to PNDs but are instead universally applicable to any type of processing device that is configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or indeed a computing resource (such as a desktop or portable personal computer (PC), mobile telephone or portable digital assistant (PDA)) executing route planning and navigation software.

It will also be apparent from the following that the teachings of the present invention even have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

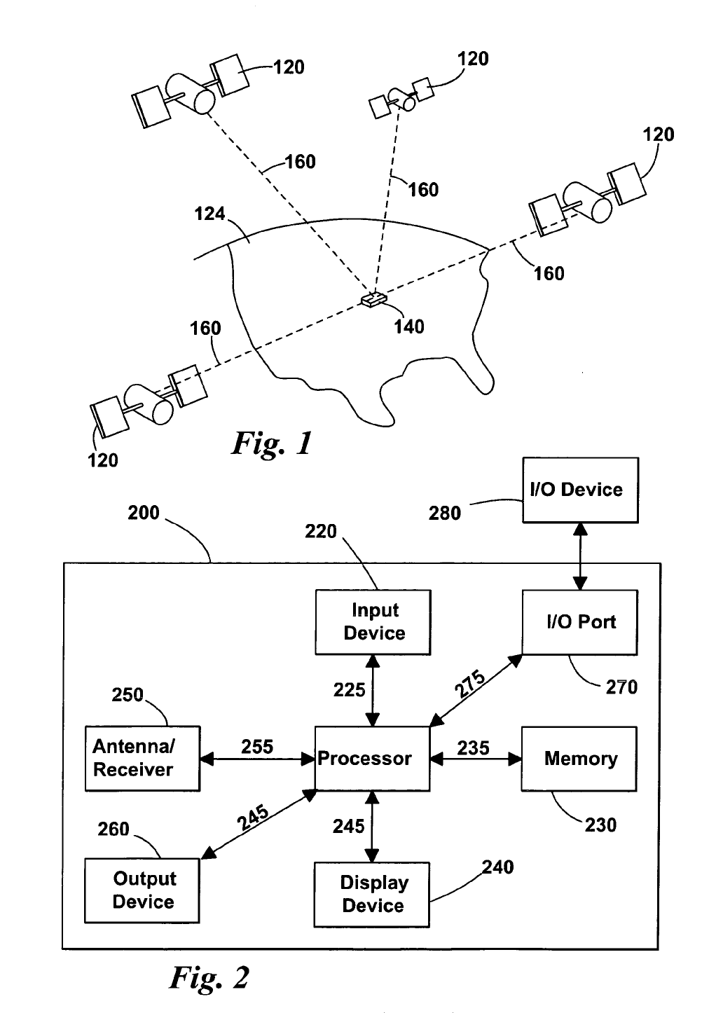

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

FIG. 2 is an illustrative representation of electronic components of a navigation device 200 according to an embodiment of the present invention, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In one arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, to output information thereto. Further, the processor 210 is operably coupled to a memory resource 230 via connection 235 and is further adapted to receive/send information from/to input/output (I/O) ports 270 via connection 275, wherein the I/O port 270 is connectible to an I/O device 280 external to the navigation device 200. The memory resource 230 comprises, for example, a volatile memory, such as a Random Access Memory (RAM) and a non-volatile memory, for example a digital memory, such as a flash memory. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

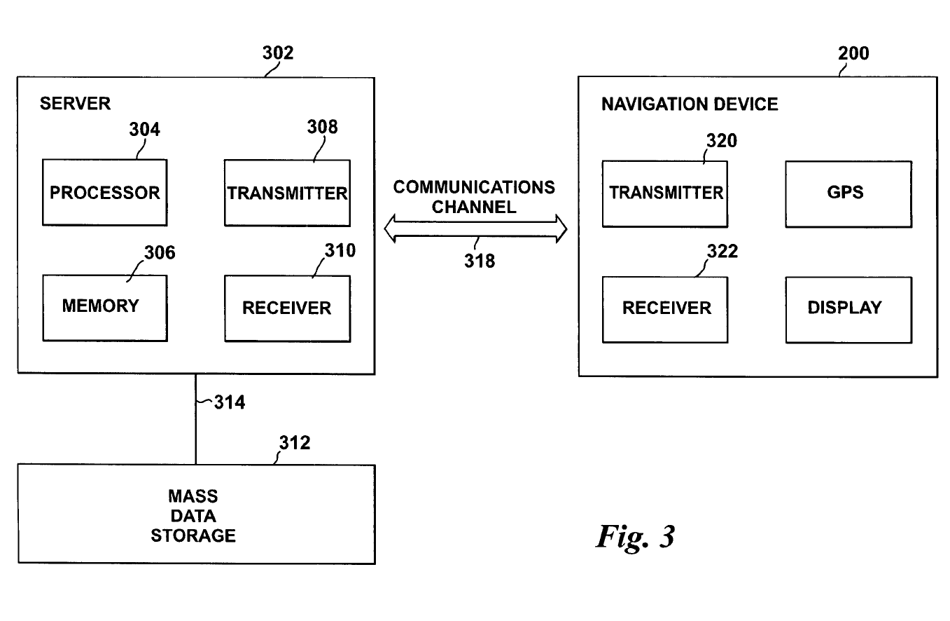

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GPRS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

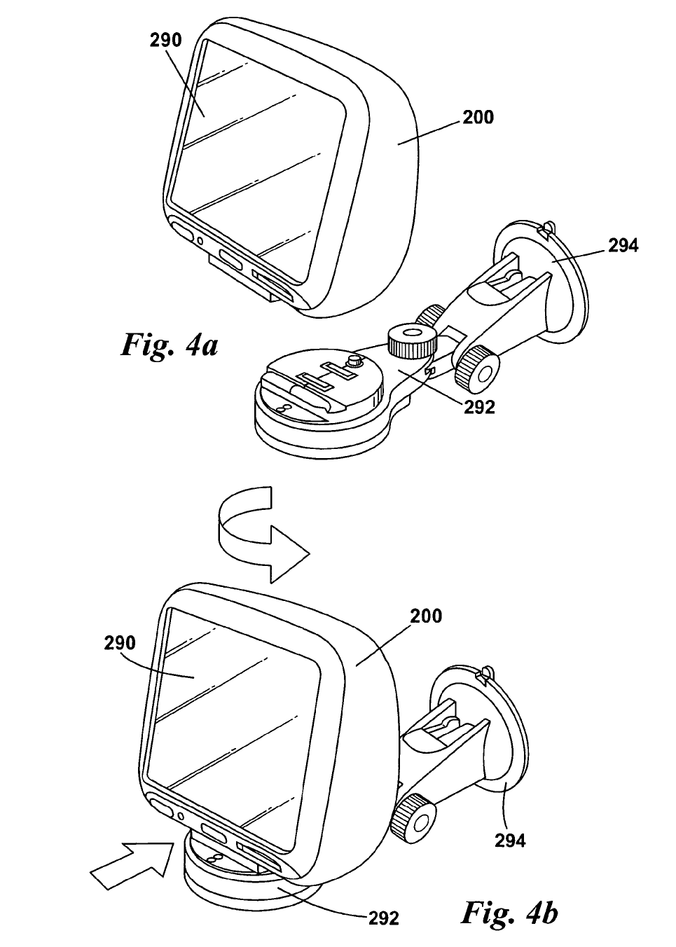

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

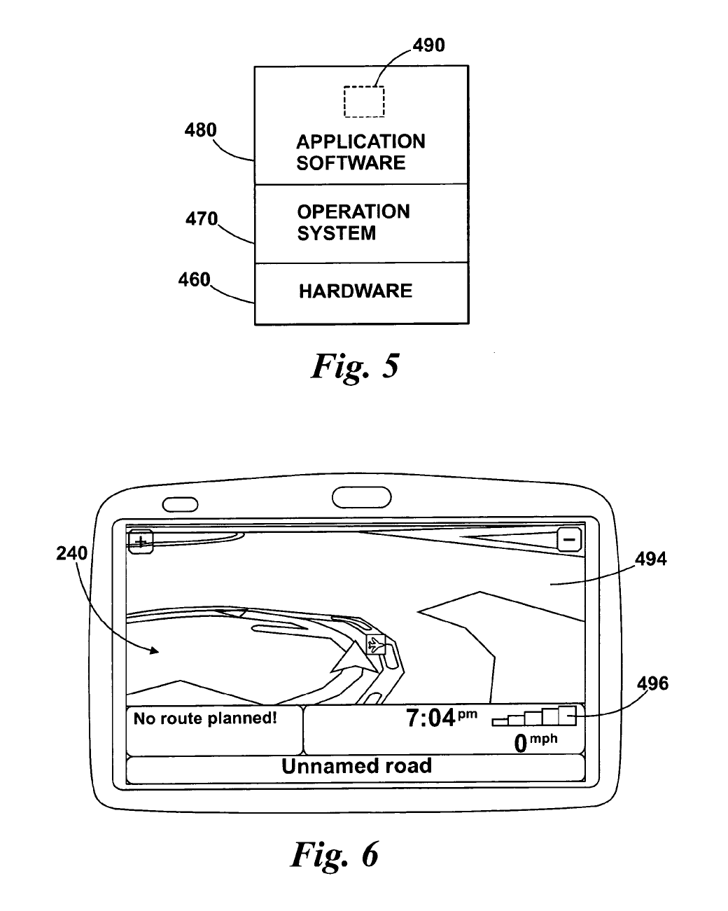

Referring now to FIG. 5 of the accompanying drawings, the memory resource 230 stores a boot loader program (not shown) that is executed by the processor 210 in order to load an operating system 470 from the memory resource 230 for execution by functional hardware components 460, which provides an environment in which application software 480 can run. The operating system 470 serves to control the functional hardware components 460 and resides between the application software 480 and the functional hardware components 460. The application software 480 provides an operational environment including the GUI that supports core functions of the navigation device 200, for example map viewing, route planning, navigation functions and any other functions associated therewith. In accordance with the embodiment described in more detail below, the application software 480 includes an alarm module 490 for providing an alarm signal to alert a user that they should return to a parked vehicle, for example due to expiry of a parking period. The function and operation of the alarm module is described in more detail below.

When the user switches on the device 200, the device 200 acquires a GPS fix and calculates (in a known manner) the current location of the navigation device 200. The location is calculated using a location determining unit comprising the antenna/receiver 250, the connection 255 and a position determining module (not shown) included in the processor 210. The user is then presented, as shown in FIG. 6, with a view in pseudo three dimensions on a touch screen display 240 of the local environment 494 in which the navigation device 200 is determined to be located, and in a region 496 of the display 240 below the local environment a series of control and status messages. The device 200 provides route planning, mapping and navigation functions to the user, in dependence on user input provided by a series of interlinked soft or virtual buttons and menu screens that can be displayed on the display 240.

It is an important feature of particular embodiments described herein that, as well as being operable to provide in-vehicle navigation and mapping functions, the navigation device can also be used to provide functions to a user when they are away from their vehicle. In particular, the navigation device 200 can be used to provide an alarm to alert a user when they should return to a parked vehicle, for example if a parking period is due to expire shortly.

As shown in FIG. 5, the processor 210 includes an alarm module 490. The navigation device 200 also includes a timing device (not shown) that comprises timing circuitry for monitoring the current time. The timing device can obtain timing signals from standard processor clock circuitry included in the processor 210 and/or can receive clock or time signals, for example GPS signals, from an external source.

The alarm module 490 is programmed to receive the current time from the timing device. The location determination unit determines the location of the device 200 using GPS signals received by the antenna/receiver 250. The location is provided to the alarm module 490.

In operation, upon parking the vehicle the user enters the return time by when they need to return to the vehicle and sets the alarm. As soon as the alarm has been set the alarm module 490 stores the current location of the device 200 in the memory 230 as the vehicle location.

The user then takes the device 200 with them upon leaving the vehicle and the alarm module 490 monitors the difference between the current time and the return time, and the location of the device 200 relative to the vehicle location, either continuously or periodically, as the user moves around away from the vehicle. The processor 210 is able to determine the quickest walking route back to the vehicle location for any given device location, and to estimate the time it would take the user to return to the vehicle (based upon average walking speed for all users, or for that particular user).

The alarm module 490 produces an alarm signal at a time that should enable the user to return to the vehicle before the expiry of the parking period, based upon the location of the device relative to the vehicle, the quickest walking route back to the vehicle and any offset time that has been set. The criteria for determining the time at which when the alarm signal is produced can be set in dependence upon user preferences.

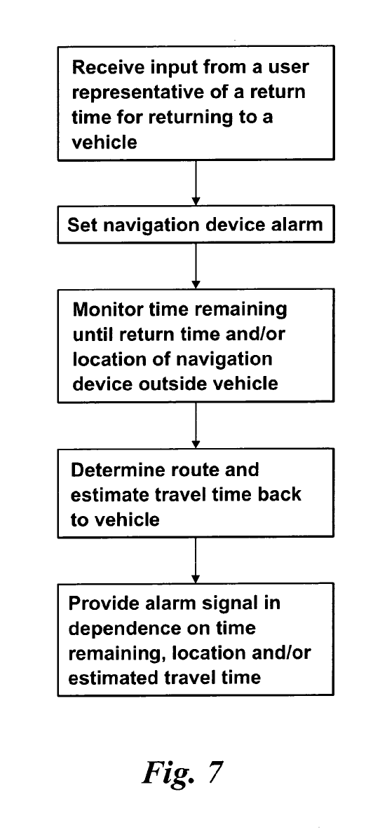

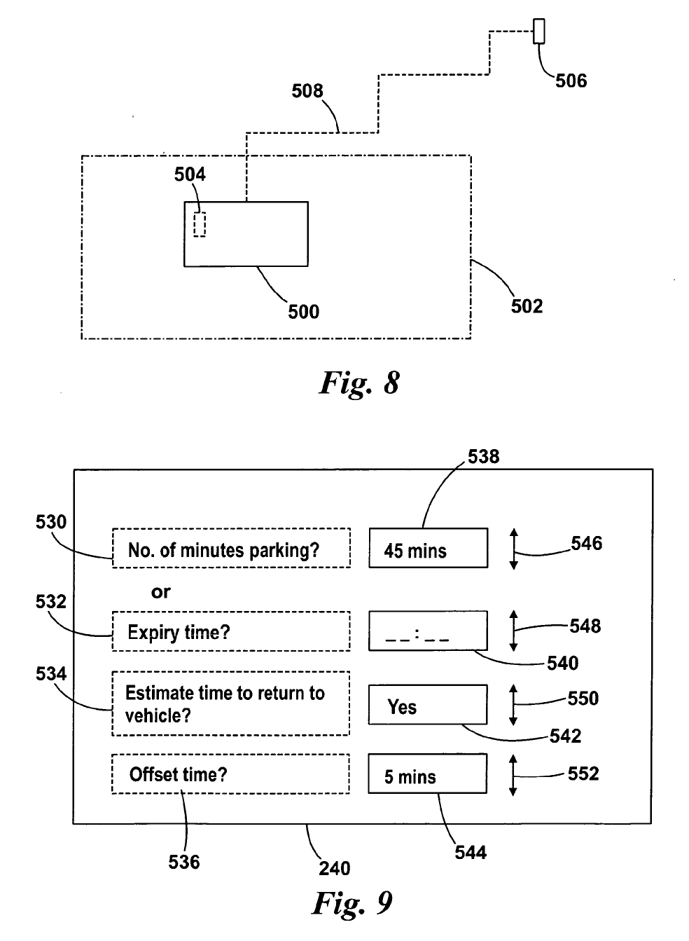

Operation of the alarm module is illustrated in overview in the flowchart of FIG. 7, and is described in more detail with reference to FIGS. 8 to 11.

Upon parking a vehicle 500 in a parking area 502, illustrated in FIG. 8, the user first buys a parking ticket authorising them to park for a parking period. The user then sets the portable navigation device 200 to warn them when it is time for them to come back to the vehicle 500, using an input screen displayed on the touch screen display 240 under control of the alarm module 490, and illustrated in FIG. 9.

The user is asked to enter the duration of the parking period or the expiry time of the parking period via questions displayed in text boxes 530 and 532. The user is also asked in text boxes 534, 536 whether they wish the portable navigation device 200 to estimate the time that will be required for the user to return to the vehicle and whether an additional offset time should be added to the estimated return time. The user enters their responses to the question in boxes 538, 540, 542 and 544 using up and down buttons 546, 548, 550 and 552 and sets the parking alarm.

Once the parking alarm has been set the processor 200 determines the current location of the vehicle using the location determination unit, and stores it in the memory 230 as the vehicle location. The device 200 then enters a sleep state to save power, under control of a power state management module included in the processor 210, and the user removes the device 200 from its mounting 504 in the vehicle 500 and takes it with them when they leave the vehicle. The power state management module is configured to control waking and sleeping states of the device 200 and to co-operate with the alarm module 490.

When 50% of the parking period, or a predetermined period (for example 5 minutes), has expired the device 200 awakens under control of the power state management module, locks the touch screen 240 (in case the device is in a bag), determines its current location 506, calculates a walking route 508 to the vehicle location 500, shown in FIG. 8, and estimates the time to walk back to the vehicle using the calculated route 508.

If the estimated time to walk back to the vehicle is greater than 5 minutes, the alarm module determines whether the current time is later than or equal to the return time (in this case the parking period expiry time) minus the sum of the estimated time to walk back to the vehicle plus an offset time of 5 minutes. If so, then the alarm module provides an alarm signal to the output device 260, which provides an audible and/or tactile warning alarm in response to the alarm signal. If not, the alarm module does not provide an alarm signal.

If the estimated time to walk back to the vehicle is less than 5 minutes, the alarm module determines whether the difference between the current time and the return time is less than or equal to 10 minutes. If so, then the alarm module provides an alarm signal to the output device 260, which sounds an audible and/or tactile warning alarm in response to the alarm signal. If not, the alarm module does not provide an alarm signal.

The device then goes back to sleep until either (a) the difference between the current time and the return time becomes less than the previously determined walking time plus 5 minutes or (b) there is 25% of the parking period left (whichever comes first). In both cases the device 200 awakens, locks the touch screen 240, determines its current position, calculates a new walking route back to the vehicle location from the newly determined current position, and estimates the new time to walk back to the vehicle using the newly calculated route.

If the new estimated time to walk back to the vehicle is greater than 5 minutes, the alarm module determines whether the current time is later than or equal to the return time (in this case the parking period expiry time) minus the sum of the estimated time to walk back to the vehicle plus an offset time of 5 minutes. If so, then the alarm module provides an alarm signal to the output device 260, which provides an audible and/or tactile warning alarm in response to the alarm signal. If not, the alarm module does not provide an alarm signal.

If the new estimated time to walk back to the vehicle is less than 5 minutes, the alarm module determines whether the difference between the current time and the return time is less than or equal to 10 minutes. If so, then the alarm module provides an alarm signal to the output device 260, which provides an audible and/or tactile warning alarm in response to the alarm signal. If not, the alarm module does not provide an alarm signal.

The device then goes to sleep again until the difference between the current time and the return time becomes less than the previously determined walking time plus 5 minutes or until there is 10% of the parking period left (whichever comes first), and repeats the procedures described in the preceding three paragraphs. The device continues to operate in that manner, waking at times corresponding to smaller and smaller percentages of the total parking period and determining whether or not to provide an alarm.

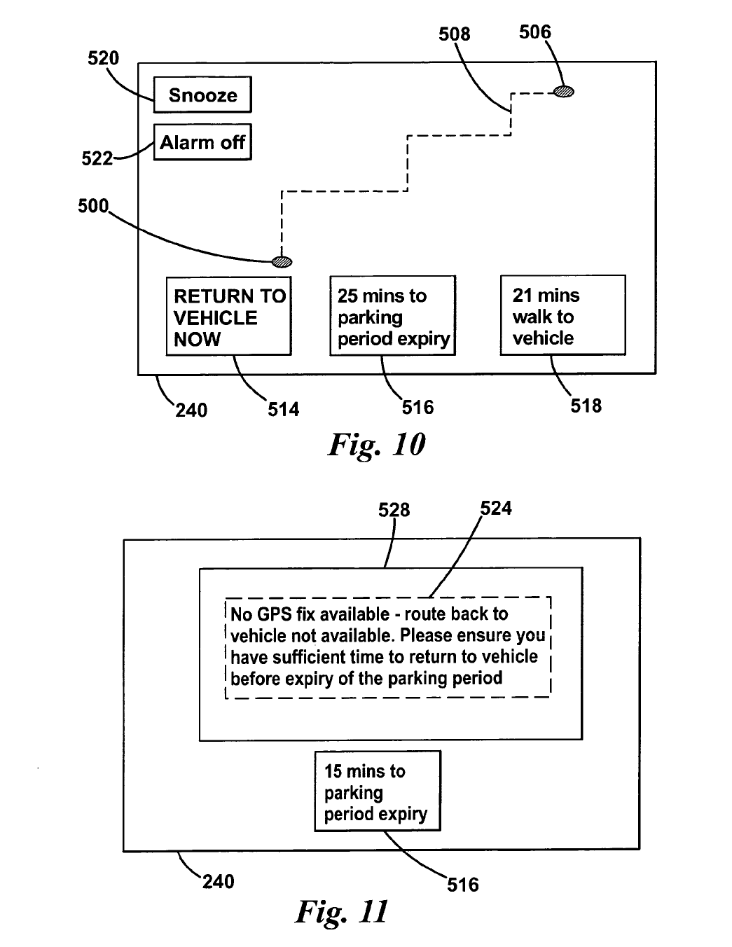

Eventually the alarm module will produce the alarm signal. As well as providing the alarm signal to the output device 260, which provides an audible and/or tactile warning alarm in response, the alarm module also provides a visual alarm by causing the screen of the display 240 to flash and to display information to the user in response to the alarm signal, as shown in FIG. 10.

A message is displayed to user in text box 514 indicating that the user should return to the vehicle now. The number of parking minutes left is also displayed as a countdown clock in display area 516 and the estimated time it will take the user to walk back to the vehicle is shown in display region 518. The walking route 508 for the user should take to walk from the current location 506 to the vehicle location 500 is displayed on a map on the display 240. In the example shown in FIG. 10 the route and the map are displayed in two dimensions but they would more usually be displayed in three dimensions or quasi-three dimensions.

A snooze button 520 and an alarm off button 522 are also displayed on the touch screen display 240. If the user presses the snooze button the alarm is stopped but is repeated a fixed time, usually a few minutes, later. If the user presses the alarm off button 522 then the alarm is stopped and the alarm module 490 provides no further alarm signals in relation to the parking period expiry time.

If the user does not press either the snooze button 520 or the alarm off button 522 then the alarm is halted after a fixed time, for example 30 seconds. In that case the alarm module 490 monitors the current location of the device 200 to determine if the user has responded to the alarm by starting to walk back towards the vehicle. The alarm module 490 can also determine if the user is walking back towards the vehicle sufficiently quickly to arrive before the expiry of the parking period.

If the user does not respond to the alarm in a desired way, either by pressing the snooze button 520 or alarm off button 522 or by walking back towards the vehicle, the device 200 tries to grab the attention of the user by repeating the audible and/or tactile and/or visual alarms every sixty seconds (for three seconds). When the parking period expires the device 200 provides audible and/or tactile and/or visual alarms for thirty seconds. After that the device 200 provides the alarm every five minutes (for three seconds) until it has done so three times (up to fifteen minutes after the parking period has expired). The device 200 then stops the alarm and the alarm module 490 provides no further alarm signals in relation to the parking period expiry time

In the above description relating to FIGS. 8 to 10, the location of the device 200 is determined from GPS signals. However, if the device 200 is, for example, in a bag or suchlike or is taken inside a building, and no GPS fix is available it can use other methods for determining its location. For example, the processor 210 can extrapolate from locations determined from previous GPS fixes, based upon the user's walking speed. Alternatively, the device 200 can use phone triangulation techniques (cell id) to determine its position based upon signals received via internal or external mobile phone technology, or request a location from a phone or network nearby that knows its location.

If the device 200 is not able to determine its location, either from a GPS fix or using the alternative methods mentioned in the preceding paragraph, then it is also not able to calculate walking routes back to the vehicle location 500, or estimate the time needed to return to the vehicle. The display 240 indicates to the user in message box 524 that the device 200 is trying to acquire a GPS fix and that a route back to the vehicle is not available, as shown in FIG. 11. Message box 524 is overlaid on a map of the area around the vehicle that is provided in region 528. The countdown to expiry of the parking period is displayed in region 516. The device 200 continues to try to determine its location every five minutes until there are ten minutes of the parking period remaining. At that point the alarm module 490 generates the alarm signal and the audible and visual alarms are provided.

It will be understood that the particular times at which the position of the device 200 is determined and routes are calculated, and the timings and offsets of the alarm signal are not limited to those described above in relation to FIGS. 8 to 11, and any suitable timings and offsets, and any suitable mode of operation that provides an alarm signal in dependence on the time remaining until a user return time, can be used. For example, in one alternative mode of operation, a sleep mode is not used and the alarm module 490 monitors the location of the device 200 and re-estimates the time to return to the vehicle periodically, for example every five seconds, or continuously. Any other suitable timings or offsets for monitoring the position of the device and providing an alarm signal may be used.

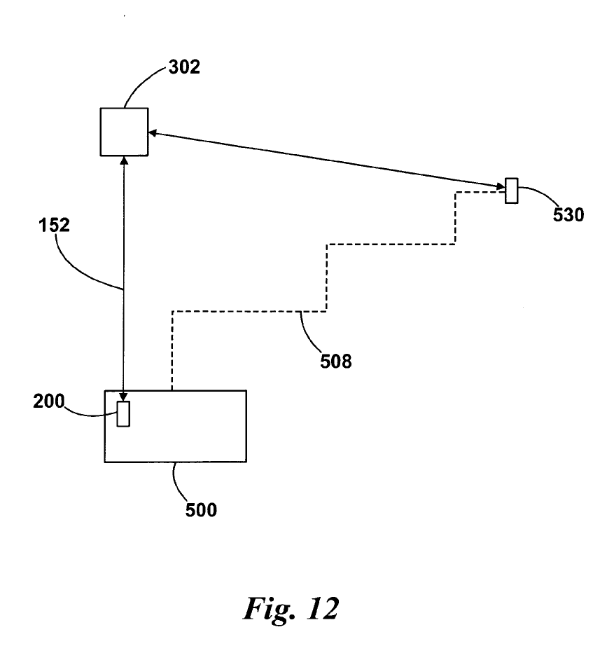

In the embodiment described in relation to FIG. 8, the navigation device 200 is removed from the vehicle 500 and carried by the user outside the vehicle 500. In other embodiments, the navigation device 200 remains in the vehicle 500 as illustrated in FIG. 12, and the user carries a mobile phone 530 or GPS-enabled user device with them. Both the navigation device 200 (via communication channel 152) and the mobile phone 530 are able to communicate with the server 302. In operation the mobile phone 530 or GPS-enabled user device is able to determine its position using known techniques and transmit that position periodically to the navigation device 200, either directly or via the server 312. The navigation device 200 monitors the current time, the parking expiry time and the location of the user (based upon the location of the mobile phone 530 or GPS-enabled user device) and provides alarm signals in accordance with the techniques described in relation to FIGS. 6 to 11. The alarm signals are transmitted from the device 200 to the mobile phone 530 or GPS-enabled user device either via the server 302 using communications channel 318 or directly from mobile phone technology included in the device 200 via a mobile network. The mobile phone 530 or GPS-enabled user device provides an audible alarm and/or text message to the user indicating that they should return to the vehicle 500, in response to a received alarm signal. The alarm signal can be sent to the mobile phone 530 as an SMS message.

In a further embodiment the navigation device 200 and/or mobile phone 530 includes an interface module for communication with an electronic parking management system, provided by some cities or towns. The electronic parking management system enables the user to pay for parking via the device 200 or mobile phone 530. According to that embodiment the user does not need to leave their car to buy a ticket, and also does not need to manually enter the parking period expiry time or duration into the device 200. Instead the parking period expiry time is set automatically upon purchasing of parking time via the device 200 or is communicated automatically to the device 200 by the electronic parking management system. The device 200 automatically knows a ticket has been bought and to what time a parking spot had been paid for. The device 200 only needs the user to verify that they wish the parking alarm to be used. As the user does not need to hide the device, lock the car, walk to buy a ticket, re-enter the car, turn the navigation device 200 on and set the alarm there may be a higher likelihood that the user would use the parking alarm.

It is also possible for the user to prolong a parking period using the device 200 or mobile phone 530, in which case device 200 extends the parking period expiry time automatically in dependence upon the additional parking time that has been purchased. In those circumstances, the user does not need to return to the vehicle 200 in response to the parking alarm.

In further embodiments, the alarm module 490 monitors the position of the vehicle and determines whether the vehicle is stationary or otherwise determines that the vehicle has been parked. The alarm module 490 compares the position to map data to determine whether the vehicle is at a location that provides paid or timed parking. If the location is a paid or timed parking location, and optionally in dependence on the current time, the alarm module 490 controls the output device 260 or display 240 to suggest to the user that they may need to pay for parking and/or prompts them to set the parking alarm. The prompt or suggestion is provided for example if the vehicle is at a car park or point of interest (POI) that included parking, or is within a predetermined distance (for example 75 m of such a car park or parking POI), or if the vehicle is in an area known to be subject to paid parking (for example in a street or zone that requires parking fees). The alarm module 490 does not provide the parking alarm prompts or suggestions every time the user reaches a destination. For example a parking alarm prompt or suggestion would not be provided if the vehicle was within a predetermined distance of a home and/or work location and/or in a zone or location for which the user has indicated that they have a parking permit.

According to embodiments described herein, or variants of such embodiments:—the device 200 is able to provide a warning to a user as to when a parking period is to expire, and to advise a user that they should return to their vehicle or extend the parking period; the device 200 is able automatically to set the alarm and provide the warning without user input, if parking can be paid for using the device 200 or through a 3^{rd} party payment system in communication with the device 200; the user can prolong the parking period using the device 200 (whilst not at or near the vehicle) if a digital payment method is available; the device 200 is able to monitor the location of the vehicle, and ask the user if they wish to set the parking alarm if it is determined that the vehicle is parked in a paid parking area; and a precise time margin for setting the alarm time can be taken into account by calculating the walking time required to reach a vehicle from a current position (or last known position).

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the present invention may be exemplified as a portable navigation device, it would be appreciated that route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst embodiments described herein implement certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

It will be understood that the present invention has been described above purely by way of example, and modifications of detail can be made within the scope of the invention.

Each feature disclosed in the description, and (where appropriate) the claims and drawings may be provided independently or in any appropriate combination.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A navigation apparatus, comprising:
an input device for input of time data representative of a user return time by when a user is to return to a parked vehicle; and
a processor configured to monitor the time remaining until the user return time and to provide an alarm signal in dependence on the time remaining.

2. Apparatus according to claim 1, wherein the user return time is a parking period expiry time.

3. Apparatus according to claim 1, further comprising a location determining unit for determining the location of the user, wherein the processor is configured to provide the alarm signal in dependence on the location of the user relative to the vehicle.

4. Apparatus according to claim 1, wherein the processor is configured to estimate the time for the user to travel to the vehicle and to provide the alarm signal in dependence upon the estimated travel time.

5. Apparatus according to claim 1, wherein the processor is configured to compare the time remaining to a threshold and to provide the alarm signal if the time remaining is less than or equal to the threshold.

6. Apparatus according to claim 5, wherein the threshold is equal to one of:—a predetermined offset time; the estimated travel time for the user to travel to the vehicle; or the estimated travel time for the user to travel to the vehicle plus a predetermined offset time.

7. Apparatus according to claim 1, that is a portable navigation device adapted for carrying and operation by a user when outside the vehicle, and comprising a location determining unit for determining the location of the device.

8. Apparatus according to claim 1, further comprising communication circuitry for communicating with a user device adapted for carrying and operation by a user when outside the vehicle, wherein the processor is configured to receive via the communication circuitry location data representative of the location of the user device.

9. Apparatus according to claim 1, configured to transmit the alarm signal to the or a user device adapted for carrying and operation by a user when outside the vehicle.

10. Apparatus according to claim 1, wherein the processor is configured to monitor for response from the user following provision of the alarm signal.

11. Apparatus according to claim 10, wherein the processor is configured to repeat the alarm signal or provide a further alarm signal, if the user does not provide a desired response to the alarm signal.

12. Apparatus according to claim 10, wherein the processor is configured to monitor travel of the user following the provision of the alarm signal and to repeat the alarm signal or to provide a further alarm signal in dependence upon travel of the user relative to the vehicle.

13. Apparatus according to claim 1, further comprising an output device responsive to the alarm signal to provide an output to a user, wherein the output comprises at least one of at least one of an audio and tactile, visual alarm, an indication of the user return time, an indication of the time remaining, an offset time, and an estimate of time to travel to the vehicle.

14. Apparatus according to claim 1, configured to determine the location of the vehicle in response to an input indicative that the vehicle is parked.

15. Apparatus according to claim 1, configured to provide an output to the user at least one of indicating that a parking payment may be required and requesting that the user enters the return time in response to an input indicative that the vehicle is parked.

16. Apparatus according to claim 15, configured to provide the output to the user in dependence upon the vehicle location.

17. Apparatus according to claim 1, wherein the processor is configured to extend the return time at least one of in response to input from a user and in response to an input indicative that a parking period has been extended.

18. A method of monitoring a user return time comprising obtaining time data representative of a user return time by when a user is to return to a parked vehicle, monitoring the time remaining until the user return time, and providing an alarm signal in dependence on the time remaining.

19. A non-transitory computer treadable medium comprising computer readable instructions executable to put into effect a method according to claim 18.
